(19) United States
(12) Patent Application Publication
(10) Pub. No.: US 2013/0117275 A1
(43) Pub. Date: May 9, 2013

(54) INDEX MONITORING SYSTEM, INDEX MONITORING METHOD AND PROGRAM

(71) Applicant: Haruka Yoshida, Tokyo (JP)

(72) Inventor: Haruka Yoshida, Tokyo (JP)

(73) Assignee: NEC CORPORATION, Tokyo (JP)

(21) Appl. No.: 13/810,316

(22) PCT Filed: Jul. 15, 2011
(86) PCT No.: PCT/JP2011/066774

§ 371 Date: Jan. 15, 2013

(30) Foreign Application Priority Data
Jul. 16, 2010 (JP) 2010-161172

(51) Int. Cl. G06F 17/30

(52) U.S. Cl. CPC G06F 17/30321
USPC 707/741

(57) ABSTRACT

Provided are an index monitoring system, an index monitoring method and a program which enable to understand a state of a monitoring target object, including a retention state of an index value.

The index monitoring system includes a retention state calculation means calculating a retention state of the index value based on the index value of the monitoring target object.

### TECHNICAL FIELD

The present invention relates to an index monitoring system, an index monitoring method and a program. More particularly, the present invention relates to an index monitoring system, an index monitoring method and a program which monitor the status of monitoring target objects.

### BACKGROUND ART

In operation management for information technology (IT) services, it has been required to efficiently utilize IT resources therefore for the purpose of stably supplying services to be provided, and reducing operational cost of services. The influence on operational cost depending on the utilization efficiency of each of the IT resources becomes particularly large in a situation where a large-scale system is operated, such as represented by a data center. For this reason, it has been an important problem how to manage the IT resources so as to enable efficient utilization for the each of the IT resources. The IT resource means processing power of an information apparatus, such as a server. The utilization efficiency of an IT resource means the proportion of an amount of actually utilized processing power relative to an amount of available processing power for an information apparatus.

Well-known examples of an index for managing the utilization efficiency of an IT resource include a central processing unit (CPU) usage rate of a relevant server or the like. This CPU usage rate indicates the proportion of a period of time (note, in this English translation document of the present PCT application document, “period of time” may be referred to as merely “period” hereinafter) during which certain software, such as a running program, causes a relevant CPU to exclusively process the software itself, and is usually expressed in %. Using such an index as described above makes it possible to monitor and manage the utilization efficiency of each of corresponding IT resources.

An example of the above-described technology is disclosed in Patent Literature (PTL) 1 listed below. In a load regulation control method disclosed in PTL 1, it is determined whether a CPU usage rate of a communication apparatus exceeds a borderline, or not, and if the CPU usage rate exceeds the borderline, a regulation corresponding to the borderline is made.

Moreover, another example of the above-described technology is disclosed in Patent Literature (PTL) 2 listed below. A traffic control apparatus disclosed in PTL 2 performs congestion control based on a CPU usage rate and a packet buffer usage rate. Moreover, upon occurrence of congestion, the traffic control apparatus performs traffic control for each subscriber and each time zone.

### CITATION LIST

### Patent Literature

PTL 1: Japanese Patent Application Unexamined Publication No. 2006-093907

PTL 2: Japanese Patent Application Unexamined Publication No. 1998(H10)-190730

### SUMMARY OF INVENTION

### Technical Problem

In the above-described load regulation control method, it is determined whether the CPU usage rate exceeds the borderline, or not, and whether a line excess duration, which is set for each borderline, has elapsed, or not. Since, the above-described load regulation control method does not include any means for outputting during how much period of time the CPU usage rate has been retained in a certain value range, there is a problem that it is difficult to understand the utilization efficiency of the IT resource with accuracy. Moreover, the above-described traffic control apparatus also has a similar problem.

An object of the present invention is to solve the above-described problem, and provides an index monitoring system, an index monitoring method and a program which enable to understand a state of a monitoring target object, including retention state of an index value thereof.

### Solution to Problem

An index monitoring system according to an aspect of the present invention includes retention state calculation means for, based on an index values related to a monitoring target object, calculating a retention state for the index value.

An index monitoring method according to another aspect of the present invention includes reading index values for a monitoring target object and calculating a retention state of the index value.

A program according to another aspect of the present invention causes a computer to execute processing, the processing includes: reading index value related to a monitoring target object and calculating a retention state for the index value.

### Advantageous Effects of Invention

An index monitoring system, an index monitoring method and a program according to the present invention enable to understand the state of the monitoring target object with accuracy.

### BRIEF DESCRIPTION OF DRAWINGS

FIG. 1 is a block diagram illustrating a configuration of an index monitoring system according to first and second exemplary embodiments of the present invention.

FIG. 2 is a table illustrating an example of measured value history information related to monitoring indexes stored in an index measurement result storage unit 1.

FIG. 3 is a table illustrating an example of a definition of value ranges (categories) in a first exemplary embodiment.

FIG. 4 is a table illustrating an example of data calculated by a retention state calculation unit 2 in a first exemplary embodiment.

FIG. 5 is a diagram illustrating an example of graph drawing performed by a retention state drawing unit 3 in a first exemplary embodiment.

FIG. 6 is a diagram illustrating another example of graph drawing performed by a retention state drawing unit 3 in a first exemplary embodiment.

FIG. 7 is a flowchart illustrating the operations of a retention state calculation unit 2 and a retention state drawing unit 3 in an index monitoring system according to a first exemplary embodiment of the present invention.

FIG. 8 is a block diagram illustrating a configuration of an index monitoring system according to a third exemplary embodiment of the present invention.

FIG. 9 is a block diagram illustrating an example of components constituting a computer 900.

### DESCRIPTION OF EMBODIMENTS

Hereinafter, exemplary embodiments of the present invention will be described in detail with reference to the drawings.

### First Exemplary Embodiment

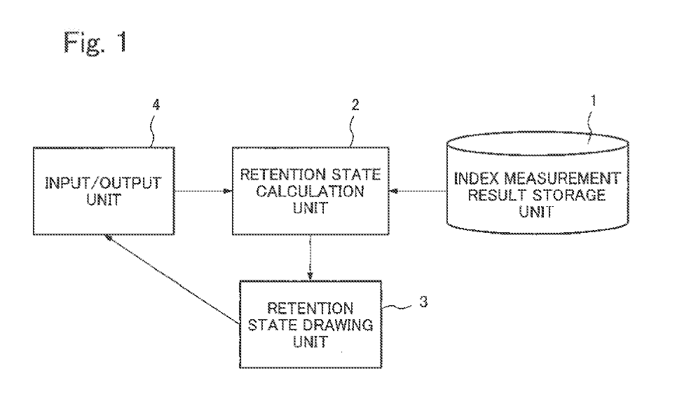

FIG. 1 is a block diagram illustrating a configuration of an index monitoring system according to a first exemplary embodiment of the present invention. An index monitoring system shown in FIG. 1 includes an index measurement result storage unit 1, a retention state calculation unit 2, a retention state drawing unit 3 and an input/output unit 4.

The index measurement result storage unit 1 stores measured values of monitoring indexes for each of monitoring target objects (not illustrated), together with corresponding time stamps or corresponding pieces of information each indicating a number of measurement times. The monitoring target object is an information processing apparatus, such as a server, a personal computer or a workstation. The monitoring index is information related to the state of a monitoring target object, such as a CPU usage rate or a memory usage rate. The monitoring index is sometimes also called just an index. Further, a value of a monitoring index and a value of an index are sometimes also called a monitoring index value and an index value, respectively.

The retention state calculation unit 2, first, refers to the measurement results of indexes, which are stored in the index measurement result storage unit 1, for each of monitoring target objects. For each of the measuring target objects, the retention state calculation unit 2 calculates, as a retention period, accumulated periods of time, within a measurement target period, during each of which one of index values of the measuring target object had been retained in one of index-value category, to which a certain one of the index values of the measuring target object belongs. That is, the retention state calculation unit 2 outputs an index-value category to which a certain one of index values of each measuring target object belongs, and accumulated periods of time during each of which one of the index values of the measuring target object had been retained in the index-value category. The index-value category is a result which is divided the index values to be able to applied into a plurality of groups. The index-value category is sometimes also called just a category. The above-described division of the index values into groups may be performed by, for example, dividing the index values at intervals of a predetermined value range.

The retention state drawing unit 3 obtains, from the retention state calculation unit 2, the index-value category to which a certain one of index values of each monitoring target object belongs and the period of time when it retains in an index-value category, and draws a graph thereof The input/output unit 4 includes an input means, such as a mouse device or a keyboard, for inputting information indicating the content of a user's operation, and an output means, such as a display.

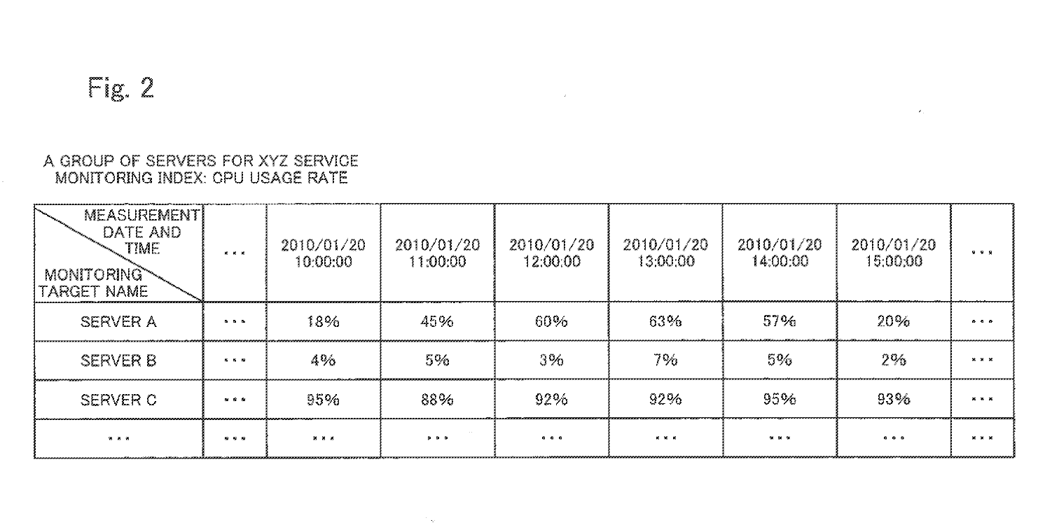

FIG. 2 is a table illustrating an example of measured value history information related to a monitoring index, which the index measurement result storage unit 1 stores therein. The measured values of monitoring indexes may be automatically acquired by a monitoring server at arbitrary measurement timing points from each monitoring target object, in which an agent function or the like is implemented, and may be registered by the monitoring server. Alternatively, a user may register the result of measurements having been performed at arbitrary timing points for monitoring indexes of each monitoring target object. In this first exemplary embodiment, targets for resource monitoring are servers. An index for monitoring a resource utilization rate is a CPU usage rate. The index measurement result storage unit 1 records the CPU usage rate of each of the serves, together with a corresponding measurement time stamp. FIG. 2 illustrates data having been recorded as the result of index measurements performed at intervals of one hour. For example, it can be understood from a table shown in FIG. 2 that, at 10: 00 on Jan. 20, 2010, the CPU usage rate of a server A is 18%, the CPU usage rate of a server B is 4%, and the CPU usage rate of a server C is 95%.

The retention state calculation unit 2 referrers to values stored in the index measurement result storage unit 1, and thereby, for each monitoring target object, calculates accumulated periods of time, within a predetermined measurement target period, during each of which one of index values of the measuring target object is retained in one of index-value categories, to which a certain one of the index values thereof belongs. The retention state calculation unit 2 may perform this calculation processing at a timing point when a user has made a request therefore via the input/output unit 4. Alternatively, the retention state calculation unit 2 may perform this calculation processing at intervals of a predetermined period of time.

In this first exemplary embodiment, a retention period of a certain monitoring target object means the sum of periods of time during each of which a monitoring index value of the monitoring target object is retained in a certain one of value ranges (categories). The value ranges (categories) may be given in advance. Alternatively, the value ranges (categories) may be calculated by performing statistical processing on values stored in the index measurement result storage unit 1. Hereinafter, it is supposed that the value ranges are given in advance.

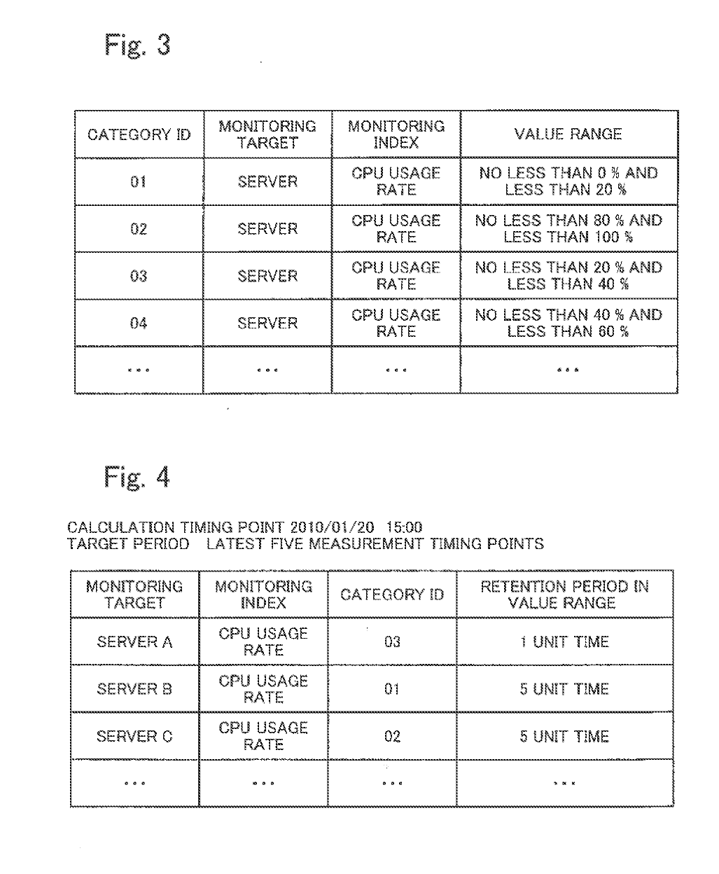

FIG. 3 is a table illustrating an example of a definition of value ranges (categories) in this first exemplary embodiment. Referring to FIG. 3, a piece of category identification (ID) is given to each of value ranges. Further, numerical values belonging to each of the value ranges are configured so as not to have any duplication and any lack among themselves. For example, a row corresponding to a category ID 01 shown in FIG. 3 indicates that, in the case where a monitoring target is a server and a monitoring index is a CPU usage rate, if a measured value of a CPU usage rate of a certain server is no less than 0% and less than 20% as a value range, the server belongs to the category 01.

In the calculation of a retention period, the retention state calculation unit 2 may determine which of value ranges a monitoring target object belongs to, in accordance with a value range to which the relevant monitoring target object belongs at a calculation timing point. That is, the retention state calculation unit 2 may calculate a retention period in a value range to which a monitoring index value of the relevant monitoring target object belongs at a calculation timing point. Alternatively, the retention state calculation unit 2 may calculate a retention period in a value range to which an average value of monitoring index values of the relevant monitoring target object, which fall within a predetermined measurement target period, belongs. Alternatively, the retention state calculation unit 2 may calculate a retention period in a value range to which an index value of the relevant monitoring target object at a date and time specified by a user belongs. Alternatively, the retention state calculation unit 2 may calculate a retention period in a value range to which a monitoring index value of the relevant monitoring target object at the latest timing point, the earliest timing point or an intermediate timing point within a predetermined measurement target period belongs.

Hereinafter, it is supposed that a retention period to be calculated for each of monitoring target objects is a retention period in a value range to which an index value of a relevant monitoring target object belongs at a calculation timing point. Moreover, it is supposed that the calculation timing point is 15:00 on Jan. 20, 2010, and a measurement target period is a period covering the latest previous five measurement timing points of each of monitoring target objects. Under these conditions, accumulated retention periods are calculated herein. As shown in FIG. 2, a CPU utilization rate of the server A changes such as 45%→60%→63%→57%→20%, and as a result, a retention period in a value range of “no less than 20% and less than 40%”, to which a measured value (20%) at the calculation timing point of 15:00 belongs, is 1 hour. A CPU usage rate of the server B changes such as 5%→3%→7%→5%→2%, and as a result, a retention period in a value range of “no less than 0% and less than 20%”, to which a measured value (2%) at the calculation timing point of 15:00 belongs, is 5 hours. A CPU usage rate of the server C changes such as 88%→92%→92%→95%→93%, and as a result, a retention period in a value range of “no less than 80%”, to which a measured value (93%) at the calculation timing point of 15:00 belongs, is 5 hours.

FIG. 4 is a table illustrating an example of data resulting from calculation performed by the retention state calculation unit 2 under the above-described condition where a calculation timing point is 15:00 on Jan. 20, 2010, and a measurement target period is a period covering the latest previous five measurement timing points. In FIG. 4, the retention state calculation unit 2 calculates a category ID and a calculated retention period of a monitoring index of each of monitoring targets (servers).

Further, in FIG. 4, the retention period is expressed in unit of “unit time”. In this first exemplary embodiment, it is supposed that one unit time is equal to one hour.

It is to be noted herein that a calculated value range of monitoring indexes of each of monitoring targets is not a value range to which a measured value at a calculation timing point belongs, such as described above, but may be a value range to which a statistical value, such as an average value of measured values within a predetermined period, belongs. In the case where an average value is used, a retention period of each of monitoring targets results in accumulated periods of time during each of which one of measured values had been retained in a value range to which the average value of the measured values belongs. For example, an average value of a CPU usage rate of the server A results in 49% (=(45%+60%+63%+57%+20%)/5). Accordingly, a retention period is equal to accumulated periods of time during each of which a record of the CPU usage rate had fallen within a value range of “no less than 40% and less than 60%”, resulting in 2 hours.

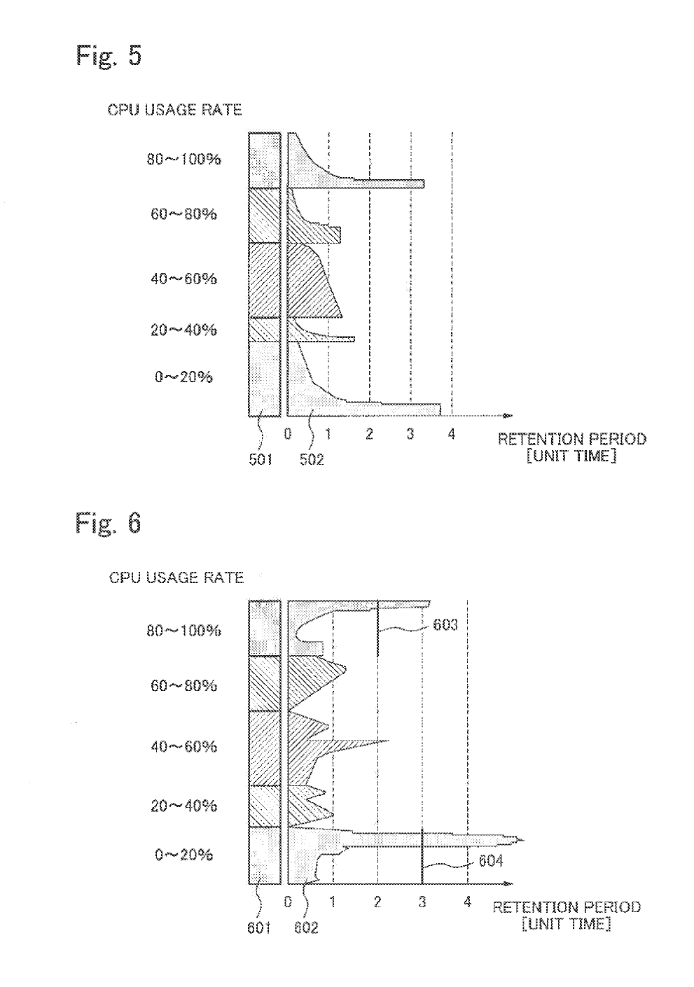

The retention state drawing unit 3 refers to retention periods of respective monitoring target objects, having been calculated by the retention state calculation unit 2, and thereby, performs graph drawing of a distribution of value ranges (categories) to which index values of the respective monitoring target objects belong, and retention periods in the individual value ranges. The above-described value range (category) to which an index value of each of monitoring target objects belongs may be determined based on a measured value of a monitoring index at a calculation timing point, an average value of measured values of the monitoring index, falling within a predetermined period, or the like. FIG. 5 is a diagram illustrating an example of graph drawing performed by the retention state drawing unit 3. Referring to FIG. 5, a component bar graph portion 501 is a component bar graph extending in a longitudinal direction, and indicating a distribution of value ranges (categories) of a monitoring index at a timing point when the retention periods of all monitoring target objects are calculated. A bar graph portion 502 attached to the component bar graph portion 501 is a bar graph extending in a lateral direction, the vertical axis thereof representing value ranges (categories) to which index values of respective monitoring target objects belong, the horizontal axis thereof representing retention periods of the respective monitoring target objects in the individual value ranges (categories). That is, the component bar graph portion 501 indicates proportions each representing the number of monitoring target objects whose index values represent the respective value ranges. Further, for each of the value ranges, the bar graph portion 502 indicates retention periods of the respective monitoring target objects, corresponding to the value range, so as to cause the value range to represent that of the component bar graph portion 501. Moreover, for example, the component bar graph portion 501 and the bar graph portion 502 may allow any point located at the same position in the vertical-axis directions thereof to represent the same index value, or the category to which the same index value belongs. In addition, the component bar graph portion 501 is sometimes also called a first graph portion. Further, the bar graph portion 502 is sometimes also called a second graph portion.

In the bar graph portion 502 shown in FIG. 5, for each of the value ranges on the vertical axis, the retention state drawing unit 3 sorts the retention periods on the horizontal axis, and indicates the sorted retention periods in order starting from a retention period having the longest period to a retention period having the shortest period. It is to be noted herein that, in the bar graph portion 502, the retention state drawing unit 3 may sort the measured values on the vertical axis in preference to others, and thereby, may perform indication in order, for example, in accordance with the largeness of each of measured values for a monitoring index at a calculation timing point. FIG. 6 is a diagram illustrating another example of graph drawing performed by the retention state drawing unit 3 in the case where measured values on the vertical axis are sorted in preference to others. Referring to FIG. 6, just like in FIG. 5, a component bar graph portion 601 is a component bar graph for representing the distribution of value ranges of a monitoring index of all monitoring target objects, and a bar graph portion 602 is a bar graph for representing retention periods of the respective monitoring target objects in each of the value ranges. It is to be noted herein that the bar graph portion 602 is different from that of FIG. 5 in the regard that, for each of the value ranges, indication is performed in order in accordance with the largeness of each of index values of the respective monitoring target objects.

A threshold value, which allows detection of the possibility of occurrence of a problem from relations between a certain category (value range) and retention periods included therein, may be determined in advance, and information representing the threshold value may be drawn on the graph. A threshold value line 603 and a threshold value line 604 shown in FIG. 6 suggest that monitoring target objects having respective retention periods whose values are positioned at a right side further than the threshold value line 603 or the threshold value line 604 (that is, monitoring target objects whose retention periods are longer than that indicated by the threshold value line 603 or the threshold value line 604) are each in a “faulty state”. That is, the threshold value line 603, which is drawn at a position where the retention period indicates “2” within a retention period range corresponding to a value range of no less than 80% and less than 100%, suggests that monitoring target objects having retention periods whose values are positioned at a right side further than the threshold value line 603 itself are likely to be uncontrollable. Further, the threshold value line 604, which is drawn at a position where the retention period indicates “3” within a retention period range corresponding to a value range of no smaller than 0% and smaller than 20%, suggests that monitoring target objects having retention periods whose values are positioned at a right side further than the threshold value line 604 itself are each in an idling state, and thus, are likely to be useless.

In addition, the above-described value range of a monitoring index of each of monitoring target objects is a value range to which a measured value of the monitoring target object at a retention period calculation timing point belongs, but may be a value range to which a statistical value, such as an average value of measured values within a predetermined period, belongs.

The graphs shown in FIGS. 5 and 6 can be used as summary information for allowing intuitive understanding of the states of resources in the whole of monitoring targets. Here, for example, portions each suggesting that at least one monitoring target object in the “faulty state” exists are explicitly drawn in FIG. 5 or FIG. 6 in advance, and a means which, upon selection of any one of the portions, allows drilling down to a list of corresponding monitoring target objects and/or detailed information related thereto may be provided. For example, when a user selects any one of portions each suggesting that at least one monitoring target object in the “faulty state” exists by using a mouse device and/or a keyboard, a list of corresponding monitoring target objects or detailed information related thereto may be indicated. In this way, in the management of IT resources, users can efficiently refer to information covering from summary information to detailed information related to monitoring target objects, thus enabling users to utilize the index monitoring system according to this first exemplary embodiment of the present invention further efficiently.

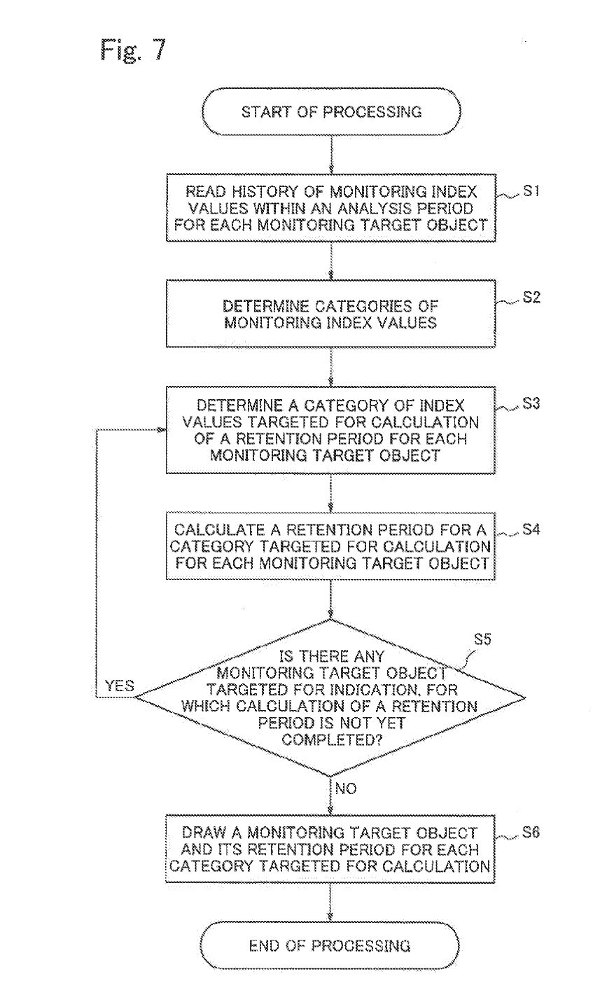

Next, the operations of this exemplary embodiment will be described in detail by using FIG. 1 and FIG. 7. FIG. 7 is a flowchart illustrating operations of the retention state calculation unit 2 and the retention state drawing unit 3 of the index monitoring system according to this first exemplary embodiment of the present invention. The retention state calculation unit 2 starts processing at a timing point when having received a user's processing request through the input/output unit 4, or at an arbitrary timing point.

First, the retention state calculation unit 2 refers monitoring index values of each of monitoring target objects within a given analysis period from the index measurement result storage unit 1 (S1), and determines categories of the monitoring index values (S2). Information related to the categories may be retained as a rule by the retention state calculation unit 2, or may be provided by a user through the input/output unit 4.

Next, for each of the monitoring target objects, the retention state calculation unit 2 determines a category of index values targeted for calculation of a retention period (S3). This category may be a category to which an index value having the latest time stamp among data stored in the index measurement result storage unit 1 belongs. Alternatively, the category may be a category to which an average value of index values falling within a retention period measurement period belongs. Alternatively, the category may be a category to which an index value at a date and time specified by a user belongs. Alternatively, the category may be a category to which an index value having a time stamp at the latest timing point, the earliest timing point or an intermediate timing point within a retention period measurement period belongs. In addition, the retention period measurement period may be the same as the given analysis period.

Next, for each of the monitoring target objects, the retention state calculation unit 2 calculates, as a retention period, accumulated periods of time, within a given analysis period, during each of which an index value had belonged to the relevant category (S4). Further, the retention state calculation unit 2 performs this processing included in S3 to S4 on all the monitoring target objects (S5). FIG. 4 illustrates an example of data having been extracted in this step. Finally, for each of all the monitoring target objects targeted for indication, the retention state drawing unit 3 indicates the category to which the monitoring index value belongs, and a retention period corresponding to the monitoring index (S6). FIG. 5 and FIG. 6 illustrate examples of this indication.

As described above, the index monitoring system according to this first exemplary embodiment of the present invention enables determination and understanding of the state of each of monitoring target objects in detail and with accuracy. It is because, for each of monitoring target objects, the retention state calculation unit 2 calculates and outputs accumulated periods of time during each of which an index value of the monitoring target object had been retained in a predetermined value range.

Moreover, in the index monitoring system according to this first exemplary embodiment of the present invention, users can intuitively understand the state of utilization efficiency of each of IT resources in the whole of monitoring target objects. It is because, for all monitoring target objects targeted for indication, the retention state drawing unit 3 indicates retention periods corresponding to respective index values of the monitoring target objects on the same graph.

### Second Exemplary Embodiment

Next, a second exemplary embodiment according to the present invention will be described. An index monitoring system according to a second exemplary embodiment of the present invention calculates the retention states of index values by performing statistical processing on the index values.

Since the configuration of the index monitoring system according to this second exemplary embodiment of the present invention is the same as that shown in FIG. 1, the description thereof is omitted herein.

In the first exemplary embodiment described above, the retention state calculation unit 2 calculates a retention period of a certain monitoring target object as accumulated periods of time, within a predetermined period, during each of which a measured value thereof had belonged to the same category as that to which an index value thereof having been defined in advance belongs. The retention state calculation unit 2 in this second exemplary embodiment calculates a retention period based on an average of variations per a unit time for measured monitoring index values falling within a predetermined period. Specifically, the retention state calculation unit 2 defines a maximum value of variations per a unit time as a difference between a maximum value and a minimum value of an index, and calculates a difference between the maximum value of variations and an average of variations of measured monitoring index values as a value corresponding to a retention period. Hereinafter, the value corresponding to a retention period will be referred to as an “average retention volume”.

Here, an average retention volume is calculated by using the example of measured value history information shown in FIG. 2 described above. First, a maximum value of variations of a monitoring index is calculated as follows: |(Maximum value of CPU usage rate)−(Minimum value of CPU usage rate)|=|100−0 |=100

Next, an average of variations per a unit time for the monitoring index (CPU usage rate) of the server A is calculated as follows: [|60−45|+|63−60|+|57−63|+|20−57|]/4 =15
Accordingly, a difference with the maximum value of variations results in 85 (=|100−15|), and this difference is handled as an average retention volume of the server A. As understood from the above-described calculation formula, the larger the variation of monitoring index values becomes, the smaller the value of an average retention volume becomes, and the smaller the variation of monitoring index values becomes, the larger the value of an average retention volume becomes. That is, the average retention volume is a value representing the smallness of a variation of monitoring index values. Further, since the average of the monitoring index values of the server A is 49% (=(45%+60%+63%+57%+20%)/5), it can be said that, for the server A, an average retention volume corresponding to a monitoring index value of 49% is 15.

In addition, for a monitoring index, the reciprocal of an average value of variations may be defined as a “retention rate”, and this retention rate may be handled as a value corresponding to the retention period. Further, in the case where an average value of variations is equal to “0”, its retention rate may be made “1”.

Since the processing operation of the index monitoring system according to this second exemplary embodiment of the present invention is the same as that of the first exemplary embodiment except for the above-described calculation of a value corresponding to the retention period, the description of the processing operation is omitted herein. That is, the index monitoring system according to this second exemplary embodiment of the present invention performs graph drawing and the like by handling the “average retention volume” or the “retention rate” having been calculated above as a value corresponding to the “retention period” in the first exemplary embodiment. In addition, since the value range (category) is unnecessary for the calculation of the “average retention volume” or the “retention rate”, the processing for the value range (category) in the first exemplary embodiment may not be performed.

In this way, the index monitoring system according to this second exemplary embodiment of the present invention brings about the same advantageous effects as those of the first exemplary embodiment without setting the value ranges (categories) of index values in advance.

It is because the retention state calculation unit 2 calculates a value corresponding to the retention period for index values falling within a predetermined value range by performing statistical processing on index values.

### Third Exemplary Embodiment

Next, a third exemplary embodiment according to the present invention will be described.

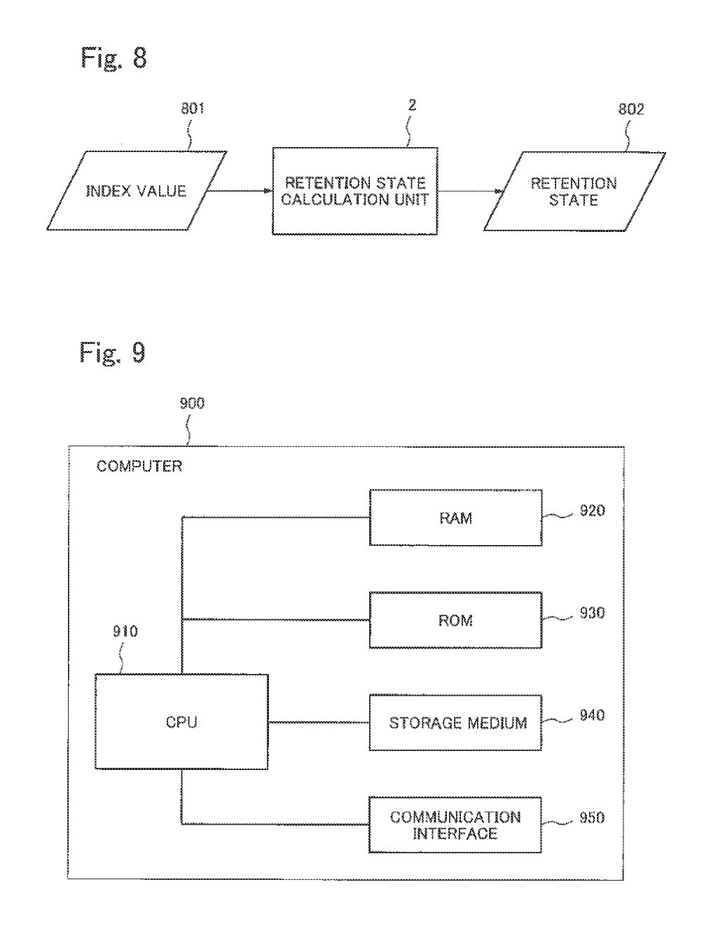

FIG. 8 is a block diagram illustrating the configuration of an index monitoring system according to a third exemplary embodiment of the present invention.

An index monitoring system shown in FIG. 8 is provided with a retention state calculation unit 2. The retention state calculation unit 2 according to this third exemplary embodiment reads in index values 801s for each of monitoring target objects. The index values 801s are data related to states, such as a CPU usage rate and a memory usage rate, for each of the monitoring target objects. Further, the retention state calculation unit 2 calculates a retention state 802 for the index values 801s based on the read-in index values 801s. As having been described in the first exemplary embodiment, the retention state 802 may be data related to a period of time during which at least one of the index values 801 s had been retained in a predetermined value range. Alternatively, as having been described in the second exemplary embodiment, the retention state 802 may be data related to a value which is obtained by calculating a variation for the index values 801s per a unit time, and the like, and which represents a retention period for the index values 801s.

As described above, the index monitoring system according to this third exemplary embodiment of the present invention enables determination and understanding of the state of each of monitoring target objects in detail and with accuracy. It is because the retention state calculation unit 2 calculates and outputs the retention state 802 for the index values 801s for each of the monitoring target objects.

Although the above-described retention state calculation unit 2 in the first exemplary embodiment calculates, as a retention period, accumulated periods of time during each of which an index value of each of monitoring target objects had been retained in a certain value range (category), it is not necessary to follow this method. For example, in place of the accumulated periods of time, a period of time, during which index values have been continuously retained in a value range (category) to which a measured index value at the latest measurement timing point belongs, may be calculated as a retention period.

The above-described index monitoring system according to each of the first to third exemplary embodiments may be realized by a dedicated hardware, or may be realized by a computer.

FIG. 9 is a block diagram illustrating an example of components constituting a computer 900. The computer 900 shown in FIG. 9 includes a CPU 910, random access memory (RAM) 920, read only memory (ROM) 930, a storage medium 940 and a communication interface 950. The above-described components of the index monitoring systems may be realized by causing the CPU 910 of the computer 900 to execute programs. Specifically, the above-described components of the index monitoring systems shown in each of FIGS. 1 and 8 may be realized by causing the CPU 910 to read in programs from the ROM 930 or the storage medium 940 and execute the programs. Further, in such a case, the present invention is constituted by cords representing relevant computer programs, or a storage medium (for example, the storage medium 940 or an attachable/detachable memory card (not illustrated)) storing therein cords representing the computer programs.

Hereinbefore, the present invention has been described with reference to exemplary embodiments, but the present invention is not limited to the exemplary embodiments described above. Various changes which can be understood by those skilled in art can be made on the configuration and the details of the present invention within the scope not departing from the gist of the present invention.

This application is based upon and claims the benefit of priority from Japanese Patent Application No. 2010-161172 filed on Jul. 16, 2010, the disclosure of which is incorporated herein in its entirety by reference.

Part of or the whole of the foregoing exemplary embodiments can be also described in such a way as that of the following supplementary notes, but the foregoing exemplary embodiments are not limited to the following supplementary notes.

### (Supplementary Note 1)

An index monitoring system including:

retention state calculation means for, based on an index value related to a monitoring target object, calculating a retention state of the index value.

### (Supplementary Note 2)

The index monitoring system according to supplementary note 1, wherein the retention state represents a category of index value which the index value belongs to, and a value of a retention period during the index value belongs to the category.

(Supplementary Note 3)

The index monitoring system according to supplementary note 1, wherein the retention state represents a value which represents smallness of a variation for the index value, and which is obtained by performing statistical processing on the index value.

(Supplementary Note 4)

The index monitoring system according to any one of supplementary notes 1 to 3, further including: retention state drawing means for generating a graph which indicates the index value and the retention state of the index value.

### (Supplementary Note 5)

The index monitoring system according to supplementary note 4, wherein the graph includes a first graph portion indicating a distribution of the index value for the monitoring target object, and a second graph portion indicating a value of the retention state for the index value for the monitoring target object.

(Supplementary Note 6)

The index monitoring system according to supplementary note 4 or supplementary note 5, wherein the graph includes a threshold-value line which, for a predetermined value range or a predetermined category of the index value, denotes a basis of determination as to whether a value of a retention state exceeds a predetermined threshold value, or not.

### (Supplementary Note 7)

An index monitoring method including: reading index value for a monitoring target object; and calculating a retention state of the index value.

### (Supplementary Note 8)

The index monitoring method according to supplementary note 7 further including:

determining a category of index value which the index value belongs to;

calculating a value of a retention period during the index value belongs to the category; and

outputting the calculated value as the retention state.

### (Supplementary Note 9)

The index monitoring method according to supplementary note 7 further including: calculating a value representing smallness of a variation for the index value by performing statistical processing on the index value; and

outputting the calculated value as the retention state.

### (Supplementary Note 10)

The index monitoring method according to any one of supplementary notes 7 to 9, further including: creating a graph which, for the monitoring target object, indicates the index value and the retention state of the index value.

### (Supplementary Note 11)

The index monitoring method according to supplementary note 10, wherein the graph includes a first graph portion which, for each of the at least one monitoring target object, indicates a distribution of the index value, and a second graph portion which, for each of the at least one monitoring target object, indicates a value of the retention state for the index value.

### (Supplementary Note 12)

The index monitoring method according to supplementary note 10 or supplementary note 11, wherein the graph includes a threshold-value line which, for a predetermined value range or a predetermined category for the index value, denotes a basis of determination as to whether a value of a retention state exceeds a predetermined threshold value, or not.

### (Supplementary Note 13)

A program causing a computer to execute processing, the processing including: reading index value related to a monitoring target object; and calculating a retention state of the index value.

### (Supplementary Note 14)

The program according to supplementary note 13, causing a computer to execute the processing, the processing further includes:

determining a category of the index value which the index value belongs to;

calculating a value of a retention period during the index value belongs to the category; and

outputting the calculated value as the retention state.

### (Supplementary Note 15)

The program according to supplementary note 13, causing a computer to execute the processing, the processing further including:

calculating a value representing smallness of the index value by performing statistical processing on the index value; and outputting the calculated value as the retention state.

### (Supplementary Note 16)

The program according to any one of supplementary notes 13 to 15, causing a computer to execute the processing, the processing further including: generating a graph which, for the monitoring target object, indicates the index value and the retention state of the index value.

### (Supplementary Note 17)

The program according to supplementary notes 16, wherein the graph includes a first graph portion which, for the monitoring target object, indicates a distribution of the index value, and a second graph portion which, for the monitoring target object, indicates a value of the retention state for the index value.

### (Supplementary Note 18)

The program according to supplementary note 16 or supplementary note 17, wherein the graph includes a threshold-value line which, for a predetermined value range or a predetermined category for the index value, denotes a basis of determination as to whether a value of a retention state exceeds a predetermined threshold value, or not.

### INDUSTRIAL APPLICABILITY

The present invention can be suitably applied to the use for managing the utilization efficiency of IT resources in IT service operation management fields. In particular, the present invention is useful when service providers, who are providing IT services at a data center or the like by providing lots of servers as resources, understand the whole IT resource utilization efficiency in the data center.

### REFERENCE SIGNS LIST

1: Index measurement result storage unit
2: Retention state calculation unit
3: Retention state drawing unit
4: Input/output unit
501, 601: Component bar graph portion
502, 602: Bar graph portion
603, 604: threshold-value line
801: Index value
802: Retention state
900: Computer
910: CPU
920: RAM
930: ROM
940: Storage medium
950: Communication interface.

1-10. (canceled)

11. An index monitoring system comprising:
a retention state calculation unit, based on an index value related to a monitoring target object, to calculate a retention state of the index value.

12. The index monitoring system according to claim 11, wherein
the retention state represents a category of index value which the index value belongs to, and a value of a retention period during the index value belongs to the category.

13. The index monitoring system according to claim 11, wherein
the retention state represents a value which represents smallness of a variation for the index value, and which is obtained by performing statistical processing on the index value.

14. The index monitoring system according to claim 11, further comprising:
a retention state drawing unit to generate a graph which indicates the index value and the retention state of the index value.

15. The index monitoring system according to claim 14, wherein
the graph includes a first graph portion indicating a distribution of the index value for the monitoring target object, and a second graph portion indicating a value of the retention state for the index value for the monitoring target object.

16. The index monitoring system according to claim 14, wherein
the graph includes a threshold-value line which, for a predetermined value range or a predetermined category of the index value, denotes a basis of determination as to whether a value of a retention state exceeds a predetermined threshold value, or not.

17. An index monitoring method comprising:
reading index value for a monitoring target object; and
calculating a retention state of the index value.

18. The index monitoring method according to claim 17 further comprising:
determining a category of index value which the index value belongs to;
calculating a value of a retention period during the index value belongs to the category; and
outputting the calculated value as the retention state.

19. The index monitoring method according to claim 17 further comprising:
calculating a value representing smallness of a variation for the index value by performing statistical processing on the index value; and
outputting the calculated value as the retention state.

20. The index monitoring method according to claim 17, further comprising:
creating a graph which, for the monitoring target object, indicates the index value and the retention state of the index value.

21. The index monitoring method according to claim 20, wherein
the graph includes a first graph portion which, for each of the at least one monitoring target object, indicates a distribution of the index value, and a second graph portion which, for each of the at least one monitoring target object, indicates a value of the retention state for the index value.

22. The index monitoring method according to claim 20, wherein
the graph includes a threshold-value line which, for a predetermined value range or a predetermined category for the index value, denotes a basis of determination as to whether a value of a retention state exceeds a predetermined threshold value, or not.

23. A non-transitory computer-readable storage media storing a program causing a computer to execute processing, the processing comprising:
reading index value related to a monitoring target object; and
calculating a retention state of the index value.

24. The non-transitory computer-readable storage media storing the program according to claim 23, causing a computer to execute the processing, the processing further comprising:
determining a category of the index value which the index value belongs to;
calculating a value of a retention period during the index value belongs to the category; and
outputting the calculated value as the retention state.

25. The non-transitory computer-readable storage media storing the program according to claim 23, causing a computer to execute the processing, the processing further including:
calculating a value representing smallness of the index value by performing statistical processing on the index value; and
outputting the calculated value as the retention state.

26. The non-transitory computer-readable storage media storing the program according to claim 23, causing a computer to execute the processing, the processing further comprising:
generating a graph which, for the monitoring target object, indicates the index value and the retention state of the index value.

27. The non-transitory computer-readable storage media storing the program according to claim 26, wherein
the graph includes a first graph portion which, for the monitoring target object, indicates a distribution of the index value, and a second graph portion which, for the monitoring target object, indicates a value of the retention state for the index value.

28. The non-transitory computer-readable storage media storing program according to claim 26, wherein
the graph includes a threshold-value line which, for a predetermined value range or a predetermined category for the index value, denotes a basis of determination as to whether a value of a retention state exceeds a predetermined threshold value, or not.
